(19) United States
(12) Patent Application Publication
(10) Pub. No.: US 2018/0118054 A1
(43) Pub. Date: May 3, 2018

(54) Adjustable Seat

(71) Applicant: DENSO International America, Inc., Southfield, MI (US)

(72) Inventors: Hannah DEVILBISS, Rochester Hills, MI (US); Blaise FRIERY, Farmington Hills, MI (US)

(21) Appl. No.: 15/341,556

(22) Filed: Nov. 2, 2016

(51) Int. Cl. B60N 2/02; B60N 2/44; B60N 2/00; B60N 2/70

(52) U.S. Cl. CPC B60N 2/0244; B60N 2/4415; B60N 2002/0268; B60N 2/70; B60N 2/002

(57) ABSTRACT

A seat system including a plurality of pressure sensors at a base portion and a backrest of a seat to sense pressure applied to the base portion and the backrest by an occupant. A plurality of actuators are at the base portion and the backrest of the seat. Each one of the plurality of actuators is configured to move an area of the seat to shape the seat to conform to an occupant thereof. A control module is configured to identify areas of high relative pressure applied to at least one of the base portion and the backrest by the occupant based on inputs from the plurality of sensors, and actuate one or more of the plurality of actuators at one or more of the areas of high relative pressure to provide pressure relief to the occupant.

### FIELD

The present disclosure relates to an adjustable seat.

### BACKGROUND

This section provides background information related to the present disclosure, which is not necessarily prior art.

Ergonomic and comfortable seating is becoming increasingly important because people are spending more and more time seated, whether in a vehicle, at a computer, at a desk, or otherwise. As autonomous vehicles increase in popularity, manufacturers are likely to encourage comfortable seating that will allow the operator to relax as the vehicle operates itself. Ergonomic and comfortable seating is also of great importance for those with back problems, as well as other physical ailments. While existing seating is most often suitable for its intended use, it is subject to improvement. For example, a seat that can more readily adapt to a user, thereby increasing user comfort, would be desirable. The present teachings provide seating, which has various advantages over existing seating, fulfills needs in the art, and provides numerous unexpected results as described herein and as those skilled in the art will recognize.

### SUMMARY

This section provides a general summary of the disclosure, and is not a comprehensive disclosure of its full scope or all of its features.

The present teachings are directed to a seat system including a plurality of pressure sensors at a base portion and a backrest of a seat to sense pressure applied to the base portion and the backrest by an occupant. A plurality of actuators are at the base portion and the backrest of the seat. Each one of the plurality of actuators is configured to move an area of the seat to shape the seat to conform to an occupant thereof. A control module is configured to identify areas of increased relative pressure applied to at least one of the base portion and the backrest by the occupant based on inputs from the plurality of pressure sensors, and actuate one or more of the plurality of actuators at one or more of the areas of increased pressure to provide pressure relief to the occupant.

The present teachings are further directed to a method for customizing a seat to an occupant. The method includes: measuring pressure exerted on the seat by the occupant with a plurality of pressure sensors of the seat; identifying areas of relatively high pressure and relatively low pressure exerted on the seat by the occupant; and selectively actuating a plurality of actuators within the seat at the areas of relatively high pressure to provide pressure relief to the occupant. Each one of the plurality of actuators is configured to move an area of the seat to shape the seat to conform to the occupant.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of select embodiments and not all possible implementations, and are not intended to limit the scope of the present disclosure.

FIG. 1 is a perspective view of a seat according to the present teachings;

FIG. 2 is a cross-sectional view taken along line 2-2 of FIG. 1;

FIG. 3 illustrates a seat system according to the present teachings; and

FIG. 4 illustrates another seat system according to the present teachings.

Corresponding reference numerals indicate corresponding parts throughout the several views of the drawings.

### DETAILED DESCRIPTION

Example embodiments will now be described more fully with reference to the accompanying drawings.

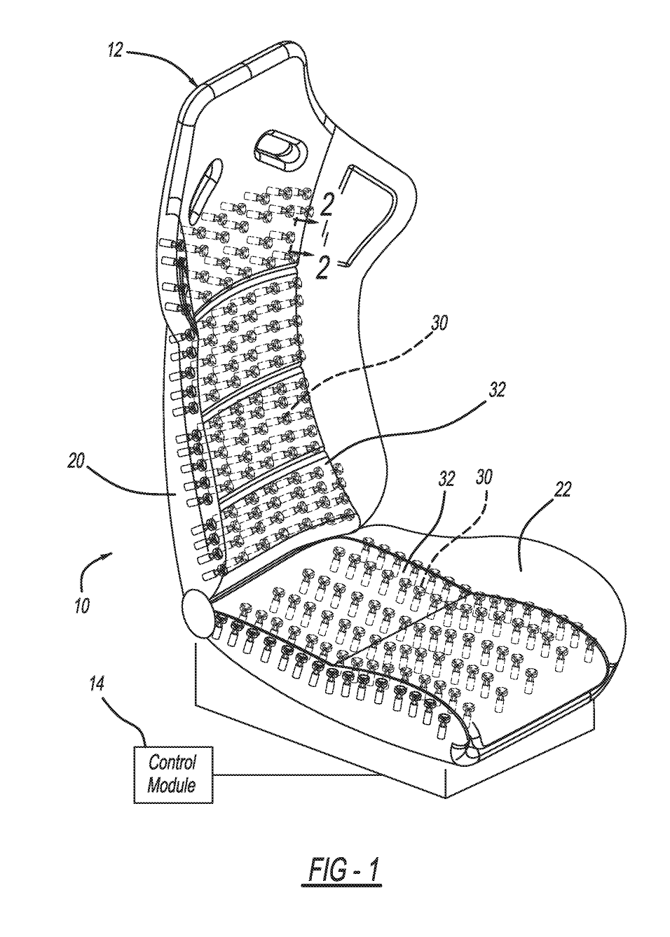

With initial reference to FIG. 1, a seat system according to the present teachings is illustrated at reference numeral 10. The seat system 10 includes a seat 12 and a control module 14. The seat 12 can be any suitable seat, such as a seat for a motor vehicle, watercraft, aircraft, office, home, commercial use, or any other suitable seat.

The seat 12 includes a backrest 20 and a base 22. Within both the backrest 20 and the base 22 are a plurality of pressure relief cells 30. Any suitable number of pressure relief cells 30 can be included in the seat 12. A cover 32 covers the cells 30. The cover 32 can be any suitable cover made out of any suitable material, such as leather, cloth, or any suitable type of upholstery.

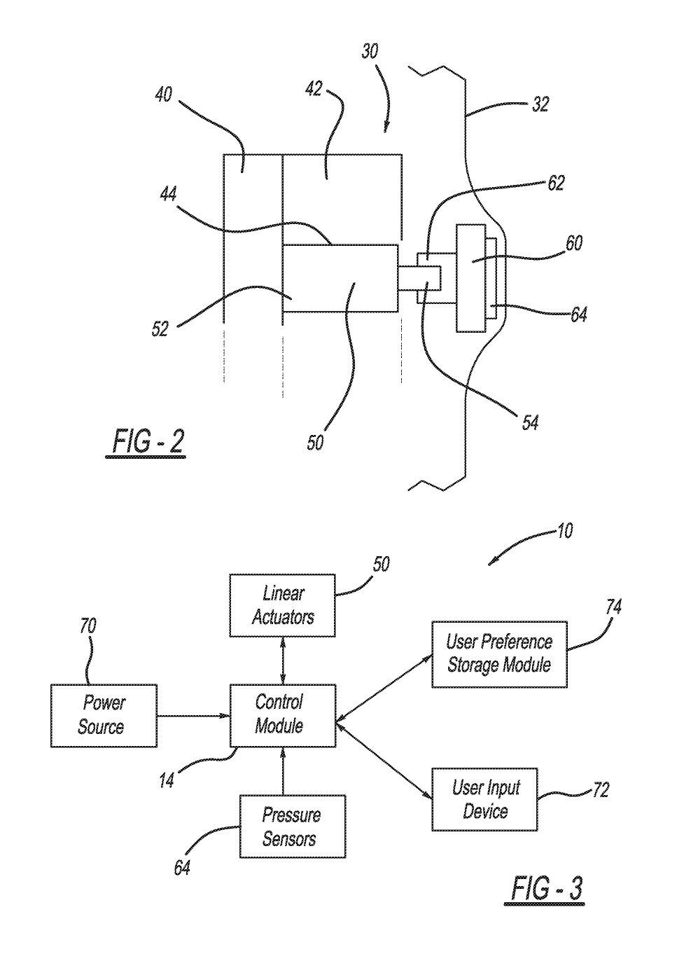

With continued reference to FIG. 1 and additional reference to FIG. 2, an exemplary one of the pressure relief cells 30 is illustrated in cross-section. The pressure relief cell 30 is mounted to a seat frame 40 of the seat 12. The cell 30 includes a mounting substrate 42, which defines an aperture 44 extending therethrough. The mounting substrate 42 is mounted to the seat frame 40 in any suitable manner, such as with any suitable adhesive and/or mechanical connection.

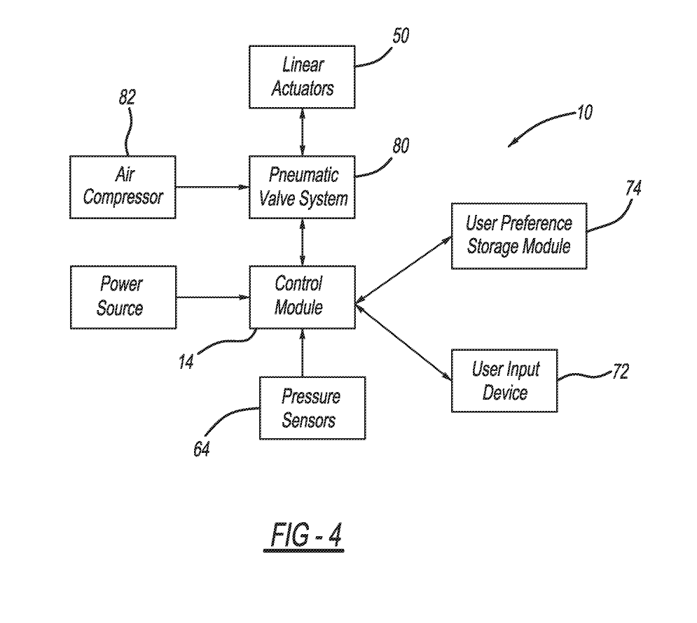

Seated within the aperture 44 of the mounting substrate 42 is a linear actuator 50. The linear actuator 50 can be secured to at least one of the mounting substrate 42 and the seat frame 40 in any suitable manner, such as with any suitable adhesive and/or mechanical connection. The linear actuator 50 includes an actuator base 52 and an extension rod 54. The linear actuator 50 is configured to extend the extension rod 54 from, or retract the extension rod 54 into, the actuator base 52 in any suitable manner. The linear actuator 50 is configured to lock in the last position from which it received power from the control module 14 so that the linear actuator 50 can lock or maintain the extension rod 54 at a position requested by the control module 14. The linear actuator 50 can be any suitable actuator configured to be actuated in any suitable manner. For example, the linear actuator 50 can be an electrically powered actuator (FIG. 3), or actuated by any suitable pneumatic valve system 80 and any suitable air compressor 82 (FIG. 4), as further described herein. The linear actuator 50 can also be hydraulically actuated.

Mounted to the extension rod 54 is a foam piece 60. The foam piece 60 can be any suitable type of foam, such as memory foam, and can have any suitable shape, such as rectangular, square, or circular. Furthermore, the foam piece 60 can be any suitable cushioning and/or stress relief material, and need not be foam. The foam 60 is connected to the extension rod 54 in any suitable manner, such as with coupling member 62 or any other suitable coupling device. The linear actuator 50 is configured to linearly actuate the foam 60 to conform the seat and the cover 32 thereof to an occupant of the seat 12, and thus relieve stress of the occupant. For example, as the extension rod 54 extends linearly outward from the base 52, the foam 60 and cover 32 extend outward to press the foam 60 and the cover 32 against the occupant (as illustrated in FIG. 3). As the extension rod 54 retracts into the base 52, the foam 60 and cover 32 will not press against the occupant (or will press against the occupant more lightly). By selectively actuating the linear actuators 50, the seat 12 can be shaped to more precisely conform to the occupant and relieve stress to the occupant.

The pressure relief cell 30 further includes a pressure sensor 64. The pressure sensor 64 can be any suitable device configured to measure pressure exerted upon the cell 30 by an occupant of the seat 12. For example, the pressure sensor 64 can be any suitable sensor configured to measure pressure exerted upon the foam 60 by an occupant of the seat 12. The pressure sensor 64 can be arranged at any suitable position about the pressure relief cell 30. For example, the pressure sensor 64 can be arranged on the foam 60 as illustrated in FIG. 2. Based on readings from the pressure sensors 64, as described further herein, the linear actuators 50 can be selectively actuated by the control module 14 to more precisely conform the shape of the seat 12 to the occupant to relieve pressure points, and thus relieve stress to the occupant.

With continued reference to FIGS. 1 and 2, and additional reference to FIG. 3, the control module 14 is in communication with each one of the pressure sensors 64 and linear actuators 50. The term “module” may be replaced with the term “circuit.” The term “module” may refer to, be part of, or include processor hardware (shared, dedicated, or group) that executes code and memory hardware (shared, dedicated, or group) that stores code executed by the processor hardware. The code is configured to provide the features of the modules, controllers, and systems described herein. The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The control module 14 is in receipt of inputs from the pressure sensors 64, and is configured to determine how much pressure an occupant of the seat 12 exerts upon each one of the pressure relief cells 30 based on the inputs from the pressure sensors 64. The control module 14 is further configured to compare the pressure exerted on each cell 30 to identify areas of relative high and relative low pressure exerted by the occupant on the seat 12. The control module 14 is then configured to selectively and individually actuate one or more of the linear actuators 50 to linearly move the extension rod 54 out of, or into, the actuator base 52 of one or more of the actuators 50 such that the foam pieces 60 are moved linearly outward against the cover 32, or inward. When moved outward, the foam pieces 60 and the cover 32 push against the occupant to relieve pressure experienced by the occupant. Movement of the extension rods 54 of the different pressure relief cells 30 inward or outward, thereby moving the foam pieces 60 and corresponding areas of the cover 32 inward or outward, effectively changes the shape of the cover 32 at the backrest 20 in the base 22 in order to conform to the occupant's body and relieve occupant pressure. The control module 14 is further configured to control the speed at which the extension rod 54 extends out from within, or retracts into, the actuator base 52.

The linear movement of the actuators 50 can be powered by any suitable power source 70. For example, the power source 70 can be a battery onboard a vehicle, and/or a vehicle alternator. The linear actuators 50 can be powered directly by the power source 70. Alternatively, and as illustrated in FIG. 3, power from the power source 70 can be routed to the linear actuators 50 through the control module 14.

The seat system 10 further includes a user input device 72 (FIGS. 3 and 4), which can be any suitable device configured to accept commands from an occupant of the seat 12, such as a touchscreen, series of buttons, series of switches, or any other suitable input device. The commands can be for movement of the linear actuators 50 to change the shape of the cover 32 and effectively change the shape of the seat 12. For example, the occupant may select an “automatic mode” using the user input device 72. In the automatic mode, the control module 14 is configured to measure the pressure exerted on each one of the cells 30 by the occupant based on inputs from the pressure sensors 64, determine which ones of the linear actuators 50 should be actuated inward or outward to provide maximum pressure relief to the occupant, and output commands to each one of the linear actuators 50 for actuating the linear actuators accordingly. For example, the control module 14 can be configured to actuate the linear actuators 50 outward at areas of relatively high pressure/stress, and actuate the linear actuators inward, or not at all, at areas of relatively low pressure/stress.

A occupant of the seat 12 may also select a “manual mode” using the input device 72. In the manual mode, the occupant can manually select one or more of the pressure relief cells 30, including one or more groups of cells 30, for inward or outward actuation to provide pressure relief at one or more desired locations of the seat 12. For example, if the occupant desires pressure relief at his or her lower back, the user input device 72 is configured to allow the occupant to select a group of cells 30 located at the lower portion of the backrest 20 for outward actuation. Such outward actuation will move the foam 60 outward and relieve the occupant of pressure at his or her lower back. Cells 30 at any other area of the seat 12 can be likewise actuated. The occupant is thus able to control the firmness or softness of the seat 12.

The occupant (or any other user) may save his or her preferred actuation settings of the pressure relief cells 30 with the user preference storage module 74. Specifically, the occupant can input his or her preferred actuation settings for the pressure relief cells 30 using the user input device 72, and select a save option, which will save his or her preferred actuation settings for the cells 30 at the user preference storage module 74.

With reference to FIG. 4, the linear actuators 50 can be powered by a pneumatic valve system 80, which is in cooperation with any suitable air compressor 82. The pneumatic valve system 80 and air compressor 82 can be any suitable pneumatic valve system and air compressor, such as that of a vehicle. For example, the pneumatic valve system 80 can be powered by a vehicle air compressor and can include a pneumatic actuator that is configured to suspend a truck cabin and/or provide braking power to the truck, or any other suitable vehicle.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” and the like, may be used herein for ease of description to describe one element or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated 90 degrees or at other orientations) and the spatially relative descriptors used herein interpreted accordingly.

What is claimed is:

1. A seat system according to the present teachings comprising:
a plurality of pressure sensors at a base portion and a backrest of a seat to sense pressure applied to the base portion and the backrest by an occupant;
a plurality of actuators at the base portion and the backrest of the seat each one of the plurality of actuators configured to move an area of the seat to shape the seat to conform to an occupant thereof; and
a control module configured to identify areas of high relative pressure applied to at least one of the base portion and the backrest by the occupant based on inputs from the plurality of sensors, and actuate one or more of the plurality of actuators at one or more of the areas of high relative pressure to provide pressure relief to the occupant.

2. The seat system of claim 1, wherein the seat is a vehicle seat, including an automobile seat.

3. The seat system of claim 1, further comprising a plurality of memory foam pieces in at least one of the base portion and the backrest of the seat, each one of the plurality of memory foam pieces is linearly movable by one of the plurality of actuators.

4. The seat system of claim 3, wherein the control module is configured to move the plurality of memory foam pieces with the linear actuators to conform the seat to body contours of an occupant thereof.

5. The seat system of claim 1, wherein the plurality of actuators are linear actuators powered by a power source, the power source including at least one of a vehicle alternator and a vehicle battery.

6. The seat system of claim 6, wherein the plurality of actuators are linear actuators actuated by an air compressor by way of a pneumatic valve system.

7. The seat system of claim 1, wherein the air compressor further powers a pneumatic actuator configured to at least one of suspend a truck cabin or provide braking power.

8. The seat system of claim 1, further comprising a user input device configured to receive inputs from the occupant for manual control of the plurality of linear actuators.

9. The seat system of claim 1, further comprising a user preference storage module configured to store predetermined settings of the plurality of linear actuators.

10. A method for customizing a seat to an occupant comprising:
measuring pressure exerted on the seat by the occupant with a plurality of pressure sensors of the seat;
identifying areas of relatively high pressure and relatively low pressure exerted on the seat by the occupant; and
selectively actuating a plurality of actuators within the seat at the areas of relatively high pressure to provide pressure relief to the occupant, each one of the plurality of actuators configured to move an area of the seat to shape the seat to conform to the occupant.

11. The method of claim 10, further comprising measuring pressure and identifying areas of relatively high pressure and relatively low pressure with a control module in receipt of inputs from the plurality of pressure sensors.

12. The method of claim 10, wherein each one of the plurality of actuators is configured to linearly move a foam piece towards or away from the occupant to relieve pressure to the occupant.

13. The method of claim 10, wherein the plurality of linear actuators are included in a base portion and a backrest portion of the seat.

14. The method of claim 10, further comprising actuating the linear actuators with a pneumatic valve system of a vehicle.

15. The method of claim 10, further comprising powering the linear actuators with a vehicle power source.

16. The method of claim 10, further comprising setting the linear actuators and foam pieces associated therewith according to a predetermined preference of the occupant.

17. The method of claim 10, further comprising arranging the linear actuators in response to commands entered by the occupant through a user input device.
